(19) United States
(12) Patent Application Publication
(10) Pub. No.: US 2005/0043195 A1
(43) Pub. Date: Feb. 24, 2005

(54) Dishwashing compositions comprising floating particles

(76) Inventors: Ralf Wiedemann, Griesheim (DE); Marcus Guzmann, Leimen (DE); Natascha Daschner, Altrip (DE)

Correspondence Address: Norris McLaughlin & Marcus, 30th Floor, 220 East 42nd Street, New York, NY, 10017, US

(21) Appl. No.: 10/343,164

(22) PCT Filed: Jul. 26, 2001
(86) PCT No.: PCT/GB01/03354

(30) Foreign Application Priority Data
Jul. 28, 2000 (GB) 0018525.6

(51) Int. Cl. C11D 1/00

(52) U.S. Cl. 510/220

(57) ABSTRACT

A machine dishwashing detergent composition is disclosed. The composition includes delayed-release solid particles comprising at least one ingredient that is intended to perform its function during the rinse cycle of an automatic dishwashing cycle wherein the particles float in water and have no more than one dimension bigger than 1 cm.

The present application relates to detergent compositions particularly for use in a domestic dishwashing machine.

Although modern dishwashing machines have in most cases a number of different cleaning programs working at different temperatures and having different duration, all the cleaning processes consist basically of the following cycles: pre-wash cycle, main wash cycle, rinse cycle and drying cycle. Between the pre-washing and the washing cycle and between the washing and the rinsing cycle the liquor in the machine is pumped off and new fresh water is fed.

Different products are used in dishwashers to achieve optimum results, these products being normally delivered at different moments during the overall machine cleaning process: a detergent is normally needed for the washing cycle and a rinse aid is normally desirable for the rinse cycle. The function of the rinse aid is to avoid that, during rinsing, water droplets are left particularly onto the glassware which droplets upon drying leave residues coming from the substances dissolved in water.

Although dishwashing machines are equipped with separate dispensing systems to dispense detergent at the wash cycle and rinse aid at the rinse cycle, products in tablet form have recently appeared in the marketplace which products, when dosed at the wash cycle, combine the functionality of a dishwashing detergent and a rinse aid.

These products consist of a tablet with a first detergent portion and a second solid portion comprising rinse aid additives, whereby means are used to prevent the second rinse aid containing portion from completely solubilising during the washing cycles. The rinse aid contained in said second portion is then mainly released at the rinse cycle where it can perform its function.

The delayed release of the rinse composition has been achieved using two different approaches.

In a first approach the solid rinse aid containing portion is formulated to be substantially water-insoluble at low temperatures (<55° C.) which are encountered during the washing cycle while it is soluble or at least dispersible at the higher temperatures of the rinse cycle.

The second approach uses chemical means to control the solubilisation of the rinse aid containing composition. During the wash cycle the washing liquor containing the detergent has normally a high ionic strength and/or a high pH. After the washing cycle the washing liquor is pumped off and fresh water comes in, causing a substantial decrease of the ionic strength and/or the pH of the washing liquor. It has been proposed to formulate the rinse aid composition including ionic strength- or pH-sensitive materials to control the solubility of the composition as a function of these two parameters.

Both approaches do require that the solid rinse-aid-containing portion survives the washing cycle and reaches the rinse cycle in a substantially unaltered form and that it is not removed from the machine by the pumping steps occurring between cycles as described above.

The products present on the market have guaranteed that the solid rinse aid containing portions are not pumped off from the machine by making them sufficiently big to prevent them from being pumped away in their undissolved state.

The requirement of a big particle size for the solid rinse aid portion is not a problem when this portion is part of a unit dose product (i.e. a tablet) because then the correct proportion of rinse aid to detergent is pre-established by the manufacturer.

Conversely the need to work with big particles is a strong limitation when wishing to formulate non-unit-dose products (i.e. powders, liquids, gels, very small tablets) Big particles will tend to settle in liquid or gel compositions and will segregate in powder compositions. Additionally it will be very difficult for the consumer to guarantee an accurate dosage of the rinse aid composition when big particles of rinse aid are used.

In PCT patent application number WO 95/29982 A1 it has been proposed to incorporate into a dishwashing detergent composition small (pref. 100-2,500μ) delayed-release composite particles with a core comprising a rinse aid material and a waxy coating encapsulating said core. Although the application claims that these particles provide an effective reduction of residual water left on dishes, the applicant has tried to use the products and has found that very poor results in terms of actual spotting on glassware can be obtained. This is a consequence of the pumping off of most of the coated particles before they can actually reach the rinse cycle.

The applicant has now surprisingly found that when compositions comprising ingredients that are intended to perform its function during the rinse cycle (i.e. rinse aids) are formulated in the form of delayed-release small particles which float in water, these particles can be successfully incorporated into dishwashing formulations without being substantially pumped off thereby providing effective rinse performance.

By particles it is meant here solid material of whatever shape having no more than one dimension bigger than 1 cm more preferably having no more than one dimension bigger than 0,5 cm even more preferably having no more than one dimension bigger than 0,2 cm. The term particle in this specification includes granules, beads, flakes, noodles and the like.

It is preferred that the particles of the invention have no dimension bigger 1 cm more preferably bigger than 0,5 cm even more preferably bigger than 0,2 cm.

When rinse particles according to the invention are to be incorporated into powder formulations it is preferred that they do not have any dimension bigger than 3 mm.

When rinse particles according to the invention are to be incorporated into liquid formulations it is preferred that they do not have any dimension bigger than 3 mm.

If the particles according to the invention are to be incorporated into formulations made in the form of small tablets, it is preferred that they do have a volume not smaller than half and not bigger than double than the dimension of the tablets with which they are mixed.

There are a variety of factors influencing the floatability of the particles: bulk density of the particles, presence of effervescent systems, surface tension between particles and water among others. It is however advantageous to use particles having a bulk density lower than 1 g/cm³.

Particles with density lower than 1 g/cm³ can be obtained by using, in the formulation of the tablets, ingredients having low density but they can also be obtained by entrapping air within the particles.

It has also been surprisingly found by the applicants that floating particles show an increase tendency to migrate and then stick to the walls of the dishwashing machine which further contributes to guarantee their survival during the pumping off cycles.

The natural tendency of floating particles to stick to the walls of the machine can be further increased by having the particle surface comprise a material which tends to adhere to metal or plastic surfaces normally found in a dishwasher. This material can be either incorporated into the particle's composition when the particle is uniform or can also be applied as a coating onto the surface of the tablet.

Although the expert in the field may well be aware of testing methods to assess the degree of stickiness of particles to specific surfaces, the following process has been found useful for this evaluation:

A 2-litre recipient equipped with a stirrer and having controllable draining means at its bottom, is filled with 1 litre water and 0,5 g. of the particles to be tested are added thereto. The liquid is agitated during 5 minutes at 200 rpm. The stirrer is then stopped and the liquid is left to stand for 5 minutes. After this period the liquid is drained out of the recipient. The particles remaining in the wall of the recipient are collected and weighted. The weight ratio of remaining particles to the weight of particles initially added is a measure of the tendency of the particles to stick to the recipient's walls. The tests may be repeated with recipients made of different materials (i.e. plastic stainless steel, aluminium . . . ) to simulate the different surfaces present in dishwashing machines.

As possible means of controlling the release of the ingredients that are intended to perform its function during the rinse cycle so that it acts mainly after the washing cycle any of the two approaches that have been explained above and have been used in dishwashing tablets with incorporated rinse aids may be used. The applicant also wishes to explicitly incorporate here by reference the means of controlling release disclosed in its PCT patent application number WO 00/06688 A1.

By particles showing a delayed release profile it is meant here, particles more than 30% wt. of which will remain substantially undissolved at the end of the last washing cycle when the particles are dosed to a MIELE dishwasher together with 30 g. of standard ICE B dishwashing detergent and the dishwasher is run at its 55° C. mild program.

According to a further aspect of the present invention there is provided a detergent composition for use in automated washing cycles including a rinse cycle, the composition including particles comprising at least one ingredient for use in the rinse cycle, wherein the particles are adapted to float in water. Preferably, the particles have no more than one dimension bigger than 1 cm.

### EXAMPLES

### Example 1

Particles (Floating particle A) as used in example 1 were prepared according to the following instructions: 80 g of paraffin wax with a melting point at 60-62° C. (Wintershall 60/62 DAB) were smoothly heated to a temperature of 80° C. Then while vigorously stirring 80 g of Synperonic LF/RA 30 (Uniqema) were added to the wax while maintaining a temperature of 70° C. Then the mixture was passed through a nozzle with a nozzle size of 0.4 mm. droplets were formed which were allowed to chill while falling through a cooling channel to result in solid beads with a size of 0.5-1.5 mm.

The particles float when added to water. They also tend to move to the side walls of a beaker when dosed to the centre of the water surface in such beaker.

These particles were then added to automatic dishwashing compositions as shown in table 1:

TABLE 1

| | Comparative | Formulation | Formulation |
|---|---|---|---|
| Ingredient | Formulation 1 | 2 | 3 |
| Disilicate | 2.70 | 2.70 | 2.70 |
| Sodiumtripolyphosphate | 32.00 | 32.00 | 32.00 |
| Sodiumcarbonate | 37.50 | 37.50 | 37.50 |
| Polymer | 4.00 | 4.00 | 4.00 |
| Floating particle B | 0.00 | 7.50 | 15.00 |
| Sodiumsulfate | 16.65 | 9.15 | 1.65 |
| Sodium percarbonate | 4.00 | 4.00 | 4.00 |
| Enzyme | 2.00 | 2.00 | 2.00 |
| Surfactant | 0.85 | 0.85 | 0.85 |
| Corrosion inhibitor | 0.15 | 0.15 | 0.15 |
| Fragrances | 0.15 | 0.15 | 0.15 |
| | 100.00 | 100.00 | 100.00 |

Formulations 1-3 were then investigated in a domestic dishwashing appliance according to their rinse aid performance. All formulations were dosed at a level of 30 g per wash. The dishwasher used was a BOSCH SMS 5062 and the cleaning program Universal 50° C. was chosen. Water hardness was 2° dH.

Test Procedure

A soil in a closed basket is placed in the lower rack of the dishwasher. The dishwasher is equipped with a number of tableware specimens. After the detergent is dosed into the dosage chamber the front door is closed and the program is started. After the program has finished, the front door is kept closed for additional 10 minutes. Then the door is fully opened. The evaluation can be started when the tableware is dry. Rating of the items is according to the instructions below. The grading presented in table 2 is generated by calculating the mean over all tableware items of similar kind. All dishes are rated separately under a lamp (suggestion: 500-1000 W-halogen light) in terms of spotting.

The Machine Load:

20 glass tumblers
20 porcelain plates
20 pieces of cutlery
   Rating for Spotting:
4=no spots on specimen surface
3=1-4 spots
2=more than 4 spots up to 25% of surface covered with spots
1=25% up to 50% of surface covered with spots

0=more than 50% of surface covered with spots

TABLE 2
Rinse aid performance of formulations 1-3

| | Glass | | | |
|---|---|---|---|---|
| | tumblers | Plates | cutlery | Over all |
| Formulation 1 | 2.0 | 2.0 | 2.1 | 2.0 |
| Formulation 2 | 2.5 | 2.4 | 2.6 | 2.5 |
| Formulation 3 | 2.9 | 2.9 | 3.3 | 3.0 |

The results show that an increasing amount of “floating particle A” yields in a significant better rinse aid performance of the detergent formulation. It should be noted that if the dishwashing machine cycle is interrupted after the wash cycle or before the rinse cycle a substantial amount of “floating particle A” can be detected in the machine.

### Example 2

Particles (Floating particle B) as used in example 2 were prepared according to the following instructions:

80 g of paraffin wax with a melting point at 46-48° C. were smoothly heated to a temperature of 55° C. Then while vigorously stirring 30 g of a fragrance oil commonly used in house hold cleaning formulations was added to the wax while maintaining a temperature of 50-55° C. Then the mixture was passed through a nozzle with a nozzle size of 0.4 mm. droplets were formed which were allowed to chill while falling through a cooling channel to result in solid beads with a size of 0.5-1.5 mm. The beads were then placed in a standard fluid bed coater and were coated with a solution comprised of:

| | |
|---|---|
| Hydroxypropylmethylcellulose | 3% |
| Polymer I | 7% |
| HCl | <1% |
| Water | 89-90% |

(Polymer I: Terpolymer comprised of the monomers methacrylmethylester (l), dimethylaminopropyl-methacrylat (m), dimethylaminopropyl-methacrylamid (n) with l/(l+m+n)=0,35; m/(l+m+n)=0,45; l+m+n=1500-1800)

The coating process was conducted until the particles gained about 4% in weight. The particles float when added to water. They also tend to move to the side walls of a beaker when dosed to the centre of the water surface in such beaker. There they stick to the walls due to a swelling of the coating layer.

These particles were then added to automatic dishwashing compositions as shown in table 3:

TABLE 3

| | Comparative | Formulation | Formulation |
|---|---|---|---|
| Ingredient | Formulation 4 | 5 | 6 |
| Disilicate | 2.70 | 2.70 | 2.70 |
| Sodiumtripolyphosphate | 32.00 | 32.00 | 32.00 |
| Sodiumcarbonate | 37.50 | 37.50 | 37.50 |
| Polymer | 4.00 | 4.00 | 4.00 |
| Sodiumsulfate | 15.80 | 14.80 | 12.80 |
| Sodium percarbonate | 4.00 | 4.00 | 4.00 |
| Enzyme | 2.00 | 2.00 | 2.00 |
| Surfactant | 0.85 | 0.85 | 0.85 |
| Corrosion inhibitor | 0.15 | 0.15 | 0.15 |
| Floating particle B | 0.00 | 2.00 | 4.00 |
| Fragrances | 1.00 | 0.00 | 0.00 |
| | 100.00 | 100.00 | 100.00 |

Formulation 4 and 6 contain almost the same amount of fragrance. Formulation 5 has only half the amount of fragrance.

Formulations 4-6 were then investigated in a domestic dishwashing appliance according to their fragrance release profile. All formulations were dosed at a level of 30 g per wash. The dishwasher used was a BOSCH SMS 5062 and the cleaning program Universal 50° C. was chosen. Water hardness was 2° dH.

Test Procedure

A dishwasher is equipped with a full load of tableware. A frozen soil cube as described in the IKW Method (IKW-Working Group Machine Dishwashing Detergents, “Method of Determination of the Cleaning Performance of Machine Dishwashing Detergent (Parts A and B)”) is placed in the bottom of the machine. After the detergent is dosed into the dosage chamber the front door is closed and the program is started. After the program has finished, the front door is kept closed for additional 5 minutes. Then the door is fully opened. The evaluation is started directly when the door is opened. Rating of the fragrance smell intensity is done by a panel of 5 people according to the instructions below. The grading presented in table 4 is generated by calculating the mean over all grades given by the panellists and over all trials.

Rating of Fragrance Smell Intensity:

4=very intense and fresh smell
3=intense and fresh smell
2=fresh smell
1=traces of smell noticeable

0=smell was not noticed

TABLE 4
fragrance smell intensity of formulations 4-6

| | Trial 1 | Trial 2 | Trial 3 | Over all |
|---|---|---|---|---|
| Formulation 1 | 1.0 | 1.2 | 1.1 | 1.1 |
| Formulation 2 | 1.6 | 1.7 | 2.1 | 2.5 |
| Formulation 3 | 3.3 | 3.1 | 2.9 | 3.0 |

The results show that an increasing amount of “floating particle B” yields in a significant better fragrance smell intensity grading by the panellists. Important is that by only using half amount of fragrance the fragrance smell intensity grading is superior when using “floating particle B” compared to a formulation with free fragrance. It should be noted that if the dishwashing machine cycle is interrupted after the wash cycle or before the rinse cycle a substantial amount of “floating particle B” can be detected in the machine.

1. Machine dishwashing detergent composition comprising delayed-release solid particles which particles have a composition comprising at least one ingredient that is intended to perform its function during the rinse cycle characterised in that said particles float in water and have no more than one dimension bigger than 1 cm.

2. Composition according to claim 1 characterised in that the floating particles have not more than one dimension bigger than 0,5 cm preferably having no more than one dimension bigger than 0,2 cm.

3. Composition according to claims 1 or 2 characterised in that the surface of the particles is made sticky to metallic or plastic surfaces.

4. Composition according to any of preceding claims characterised in that the particle has a bulk density lower than 1 g/cm³.

5. Composition according to any of preceding claims characterised in that the solid particles remain substantially undissolved in an amount of at least 30% at the end of the last washing cycle when the particles are dosed to a MIELE dishwasher together with 30 g. of standard ICE B dishwashing detergent and the dishwasher is run at its 55° C. mild program.

6. Composition according to any of preceding claims characterised in that the particle is substantially water-insoluble at low temperatures (<55° C.) and it is soluble or at least dispersible at the higher temperatures of the rinse cycle.

7. Composition according to any of preceding claims characterised in that the particle is substantially insoluble at relatively high ionic strength and/or high pH and it is solubilised upon decrease of pH or ionic strength.

8. Composition according to claims 1 to 6 characterised in that the particle comprises a rinse additive.

9. Composition according to claims 1 to 6 characterised in that the particle comprises a fragrance.

10. Composition according to the invention substantially as hereinbefore described with reference to any one of Examples 1 and 2.
